(19) United States
(12) Patent Application Publication
(10) Pub. No.: US 2011/0089841 A1
(43) Pub. Date: Apr. 21, 2011

(54) CONTROL INFORMATION FOR CONTROLLING LIGHT-SYSTEM

(75) Inventors: Harald Josef Gunther Radermacher, Aachen (DE); Matthias Wendt, Wuerselen (DE); Reinhold Elferich, Aachen (DE)

(73) Assignee: KONINKLIJKE PHILIPS ELECTRONICS N.V., EINDHOVEN (NL)

(21) Appl. No.: 12/993,278

(22) PCT Filed: May 25, 2009
(86) PCT No.: PCT/IB2009/052178

§ 371 Date: Nov. 18, 2010

(30) Foreign Application Priority Data
May 29, 2008 (EP) 08104157.6

(51) Int. Cl. H05B 37/02

(52) U.S. Cl. 315/149; 315/363

(57) ABSTRACT

Devices (1) comprise receivers (11) for receiving signals (4) coming from signal-systems (5) at objects (3) and comprise converters (12) for converting the signals (4) into control information (7, 8) for controlling light-systems (2) for illuminating the objects (3). The signal-system (5) may comprise a sensor (51, 52) for sensing light (41-44) and for providing sensing information and a transmitter (53) for transmitting the signal (4) comprising the sensing information to the device (1). Alternatively the signal-system (5) may comprise a reflector (54) for converting light (41-44) into reflected light or may comprise a light source (55) for providing light (56), whereby the receiver (11) comprises a sensor (19) for sensing the reflected light or the light (56) and for providing the sensing information (7, 8). The device (1) may comprise an analyzer (14) for analyzing the sensing information (7, 8) and a memory (15) for storing location information and/or light information and/or signal-system information and a generator (16) for generating search information for letting the light-system (2) search for the signal-system (5).

### FIELD OF THE INVENTION

The invention relates to a device for providing control information for controlling a light-system for illuminating an object, and also relates to a light-system, to a signal-system, and to a method.

Examples of such a light-system are light-systems comprising one or more adjustable light spots.

### BACKGROUND OF THE INVENTION

U.S. Pat. No. 6,079,862 discloses automatic tracking lighting equipment for automatically tracking a target to be illuminated. A spotlight is supported for pivoting in horizontal and vertical directions on a ceiling surface. A horizontal drive mechanism changes the horizontal angle of the spotlight and a vertical drive mechanism changes the vertical angle of the spotlight. A CCD camera picks up the image of a target area to be illuminated. An image recognition unit processes the image from the CCD camera to recognize the target to be illuminated and to specify its coordinates. A coordinate calculation unit calculates how far to move the spotlight based on a distance of the target to be illuminated. A movable control unit converts the output of the coordinate calculation unit into drive signals for the horizontal drive mechanism and for the vertical drive mechanism and outputs drive signals to pivot the spotlight in a desired direction. This automatic tracking lighting equipment is relatively complex.

### SUMMARY OF THE INVENTION

It is an object of the invention to provide a relatively simple device. Further objects of the invention are to provide a light-system, a signal-system, and a method.

According to a first aspect of the invention, a device is provided for providing control information for controlling a light-system for illuminating an object, the device comprising

a receiver for receiving a signal coming from a signal-system at the object, and

a converter for converting the signal into the control information.

By providing the device with a receiver for receiving a signal coming from a signal-system located near an object to be illuminated by for example one or more adjustable light spots of the light-system, and by providing the device with a converter for converting this signal into the control information for controlling (the one or more adjustable light spots of) the light-system, a relatively simple device has been created.

Instead of being located close to the object, the signal-system may be connected to this object or held by this object or integrated into a part of this object. The object may be a moving or non-moving person or a moving or non-moving thing.

According to an embodiment, the signal-system comprises

a sensor for sensing light and for providing sensing information, and

a transmitter for transmitting the signal comprising the sensing information to the device.

In this case, light at the object is converted into sensing information, and this sensing information is transmitted to the device, preferably wirelessly.

According to an embodiment, the converter comprises an analyzer for analyzing the sensing information in the signal and a memory for storing location information and/or light information and/or signal-system information, and the device further comprises a generator for generating search information for letting the light-system search for the signal-system. According to a first option, the analyzer analyses the sensing information. In this case, the sensing information provided by the sensor comprises sufficient information for doing said analysis. According to a second option, the memory stores location information defining a location of the light spot and/or of the object and/or of an environment of the object, and the memory stores light information defining the light sensed by the sensor, and the memory stores signal-system information defining characteristics of the sensor, such as a sensor sensitivity with respect to a polarization or a pattern or a modulation or a wavelength of the light. In this case, the analyzer analyses the sensing information, thereby using one or more pieces of said information stored in the memory. According to a third option, the generator generates search information for letting the light-system search for the signal-system. In this case, the light spot is for example moved between different positions and/or is for example aimed at different targets, and the analyzer analyses the different sensing information, thereby possibly using one or more pieces of said information stored in the memory.

According to an embodiment, the control information comprises an aiming parameter and/or a location parameter and/or a light parameter, and the light comprises an individualization parameter, and the light comes from a light of the light-system or from another light source. The aiming parameter defines how to aim the light spot, the location parameter defines a location of the light spot, and the light parameter defines for example an intensity or a color of the light to be supplied to the sensor. The individualization parameter defines for example a code in this light or a polarization or a pattern or a modulation or a wavelength of this light. The light may come from the light spot itself or from another light source coupled to the light spot.

According to an embodiment, the light-system comprises an adjustable light spot and a further adjustable light spot, and/or the signal-system further comprises a further sensor for sensing further light and for providing further sensing information. Especially in case of more than one light spot being used and more than one sensor being used, the individualization parameter can be used advantageously. Further, it becomes possible to do a search per light spot, and to match a light spot and an object, and to select a best sensor out of two or more sensors per object, etc.

According to an embodiment, the signal-system comprises a reflector for converting light into reflected light, the signal comprises the reflected light, and the receiver comprises a sensor for sensing the reflected light and for providing sensing information and/or a sensor array for sensing the reflected light and for providing sensing information. The reflector may be an omni-directional reflector or a reflector having directional preferences. The reflected light is sensed and converted into sensing information at the device.

According to an embodiment, the converter further comprises an analyzer for analyzing the sensing information and a memory for storing location information and/or light information and/or receiver information and/or signal-system information, and the device further comprises a generator for generating search information for letting the light-system search for the signal-system. This embodiment corresponds to an embodiment discussed before, whereby this time the receiver information is defining characteristics of the sensor (array), and the signal-system information is defining characteristics of the reflector.

According to an embodiment, the control information comprises an aiming parameter and/or a location parameter and/or a light parameter, and the light and/or the reflected light comprises an individualization parameter, and the light comes from a light of the light-system or from another light source. This embodiment corresponds to an embodiment discussed before, whereby this time the individualization parameter may be added before reflection (in or via the light spot or in or via the other light source or before an input of the reflector) or during reflection (in or via the reflector) or after reflection (behind an output of the reflector).

According to an embodiment, the signal-system comprises a light source for providing light, the signal comprises the light, and the receiver comprises a sensor for sensing the light and for providing sensing information and/or a sensor array for sensing the light and for providing sensing information. The light source may be an omni-directional light source or a light source having directional preferences. The light is sensed and converted into sensing information at the device.

According to an embodiment, the converter further comprises an analyzer for analyzing the sensing information and a memory for storing location information and/or light information and/or receiver information and/or signal-system information, and the device further comprises a generator for generating search information for letting the light-system search for the signal-system. This embodiment corresponds to an embodiment discussed before, whereby this time the receiver information is defining characteristics of the sensor (array), and the signal-system information is defining characteristics of the light source.

According to an embodiment, the control information comprises an aiming parameter and/or a location parameter and/or a light parameter, and the light comprises an individualization parameter. This embodiment corresponds to an embodiment discussed before, whereby this time the individualization parameter may be added during light generation (at the light source via for example a manipulation of the light source etc.) or after light generation (behind the light source via for example a filter etc.).

According to an embodiment, the device further comprises an indicator for indicating the control information to a person for controlling a light-system, or the device further comprises a controller for automatically controlling the light-system in response to the control information. According to a first option, the device is used for informing a person, with the indicator being a display or another optical or acoustical or tactile indicator. According to a second option, the device is used for automatic control. Both options may be combined, for example to get automatic control under human supervision.

According to a second aspect of the invention, a light-system is provided comprising the device.

According to a third aspect of the invention, a signal-system is provided, which signal-system is to be used at an object for supplying a signal to a device for providing control information for controlling a light-system for illuminating the object, the device comprising a receiver for receiving the signal coming from the signal-system and comprising a converter for converting the signal into the control information, the signal-system comprising

either a sensor for sensing light and for providing sensing information and a transmitter for transmitting the signal comprising the sensing information to the device,

or a reflector for converting light into reflected light, the signal comprising the reflected light, and the receiver comprising a sensor for sensing the reflected light and for providing sensing information and/or a sensor array for sensing the reflected light and for providing sensing information,

or a light source for providing light, the signal comprising the light, and the receiver comprising a sensor for sensing the light and for providing sensing information and/or a sensor array for sensing the light and for providing sensing information.

According to a fourth aspect of the invention, a method is provided for providing control information for controlling a light-system for illuminating an object, the method comprising the steps of

receiving a signal coming from a signal-system at the object, and

converting the signal into the control information.

Embodiments of the light-system and of the signal-system and of the method correspond with the embodiments of the device.

An insight might be that an object to be illuminated needs to supply a signal to a device for controlling a light-system for illuminating the object.

A basic idea might be that, for controlling a light-system for illuminating an object, control information is to be provided by supplying a signal from a signal-system at the object to a device and by converting the signal into the control information at the device.

A problem to provide a relatively simple device is solved. An advantage might be that simplicity increases robustness and efficiency.

These and other aspects of the invention are apparent from and will be elucidated with reference to the embodiment(s) described hereinafter.

### BRIEF DESCRIPTION OF THE DRAWINGS

In the drawings:

FIG. 1 shows an embodiment of a device according to the invention and of a signal-system (with a sensor) according to the invention,

FIG. 2 shows an embodiment of a device according to the invention and of a signal-system (with a reflector) according to the invention, and

FIG. 3 shows an embodiment of a device according to the invention and of a signal-system (with a light source) according to the invention.

### DETAILED DESCRIPTION OF EMBODIMENTS

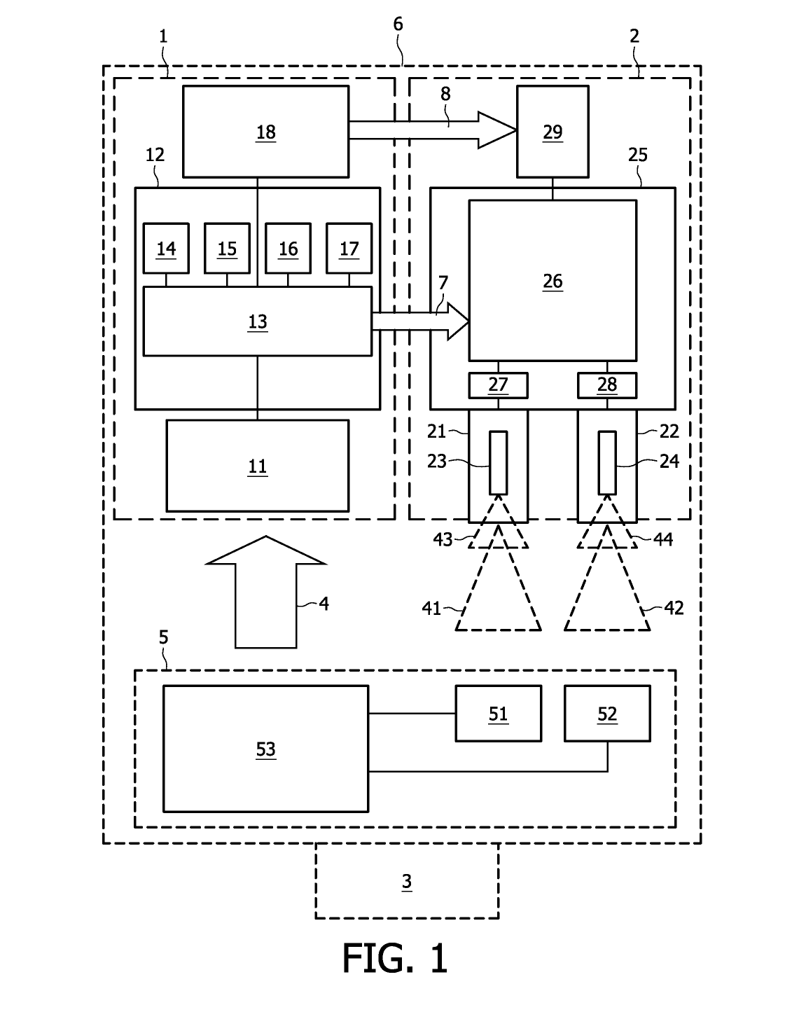

In the FIG. 1, an embodiment of a device 1 according to the invention and of a signal-system 5 (with a sensor) according to the invention is shown. The device 1 comprises a receiver 11 for receiving a signal 4 coming from the signal-system 5 located near the object 3 or coupled to this object 3 or integrated into a part of this object 3 or held by this object 3 etc. The object 3 may be a moving or non-moving person or a moving or non-moving thing. The device 1 further comprises a converter 12 for converting the signal 4 into control information 7, 8 for controlling a light-system 2 for example comprising an adjustable light spot 21 for illuminating the object 3.

The converter 12 may comprise a controller 13 for providing the control information 7 to the light-system 2 for automatically controlling the light-system 2 in response to the control information 7. In addition, there could flow further information in an opposite direction to let the light-system 2 report its current status to the device 1. This further information can be used by the device 1 to find out about a maximum possible and currently used adjustment range etc. The device 1 may further comprise an indicator 18 for example coupled to the controller 13 directly or for example coupled to the controller 13 indirectly via an indicator-interface 17 for indicating the control information 8 to a person for controlling the light-system 2 via a man-machine-interface 29. Such an indicator 18 may be a display or any other kind of optical or acoustical or tactile indicator.

The light-system 2 may further comprise another light spot 22, and each light spot 21, 22 may comprise or be coupled to another light source 23, 24. The light spot 21 (22) generates light 41 (42) and the other light source 23 (24) generates light 43 (44). The light spot 21 (22) is coupled to a processor 26 via an interface 27 (28). The processor 26 may receive the control information 7 and may further be coupled to the man-machine-interface 29 for receiving the control information 8. The interface 27 (28) may be mechanical and/or electrical interface, and the combination of the interfaces 27, 28 and the processor 26 forms a light-spot-controller 25.

The signal-system 5 comprises a sensor 51 for sensing the light 41 and/or 43 and for providing sensing information. The signal-system 5 further comprises a transmitter 53 for transmitting the signal 4 comprising the sensing information to the receiver 11 of the device 1. The signal-system 5 may further comprise a sensor 52 for sensing the light 42 and/or 44 and for providing further sensing information. The sensor 51, 52 may include a sensor array. Alternatively, each sensor 51, 52 may be used for sensing light 41, 42 coming from two or more light spots 21, 22 and/or for sensing light 43, 44 coming from two or more other light sources 23, 24.

The converter 12 may comprise an analyzer 14 for analyzing the sensing information in the signal 4 and a memory 15 for storing location information and/or light information and/or signal-system information and a generator 16 for generating search information for letting the light-system 2 search for the signal-system 5. Alternatively, the generator 16 may be located outside the converter 12. One or more of the units 12-16 may form part of a processor-system.

According to a first option, the analyzer 14 analyses the sensing information. In this case, the sensing information provided by the sensor 51, 52 comprises sufficient information for doing said analysis. According to a second option, the memory 15 stores location information defining a location of the light spot 21, 22 and/or of the object 3 and/or of an environment of the object 3, and the memory 15 stores light information defining the light 41-44 sensed by the sensor 51, 52, and the memory 15 stores signal-system information defining characteristics of the sensor 51, 52, such as a sensor sensitivity with respect to a polarization or a pattern or a modulation or a wavelength of the light 41-44. In this case, the analyzer 14 analyses the sensing information, thereby using one or more pieces of said information stored in the memory 15. According to a third option, the generator 16 generates search information for letting the light-system 2 search for the signal-system 5. In this case, the light spot 21, 22 is for example moved between different positions and/or is for example aimed at different targets, and the analyzer 14 analyses the different sensing information, thereby possibly using one or more pieces of said information stored in the memory 15.

The control information 7, 8 may comprise an aiming parameter and/or a location parameter and/or a light parameter, and the light 41-44 may comprise an individualization parameter, and the light 41-44 may come from the light spot 21, 22 and/or from the other light source 23, 24. The aiming parameter defines how to aim the light spot 21, 22, the location parameter defines a location of the light spot 21, 22, and the light parameter defines for example an intensity or a color of the light 41-44 to be sensed by the sensor 51, 52. The individualization parameter defines for example a code in this light 41-44 or a polarization or a pattern or a modulation or a wavelength of this light 41-44, that may come from the light spot 21, 22 itself or from the other light source 23, 24 coupled to the light spot 21, 22.

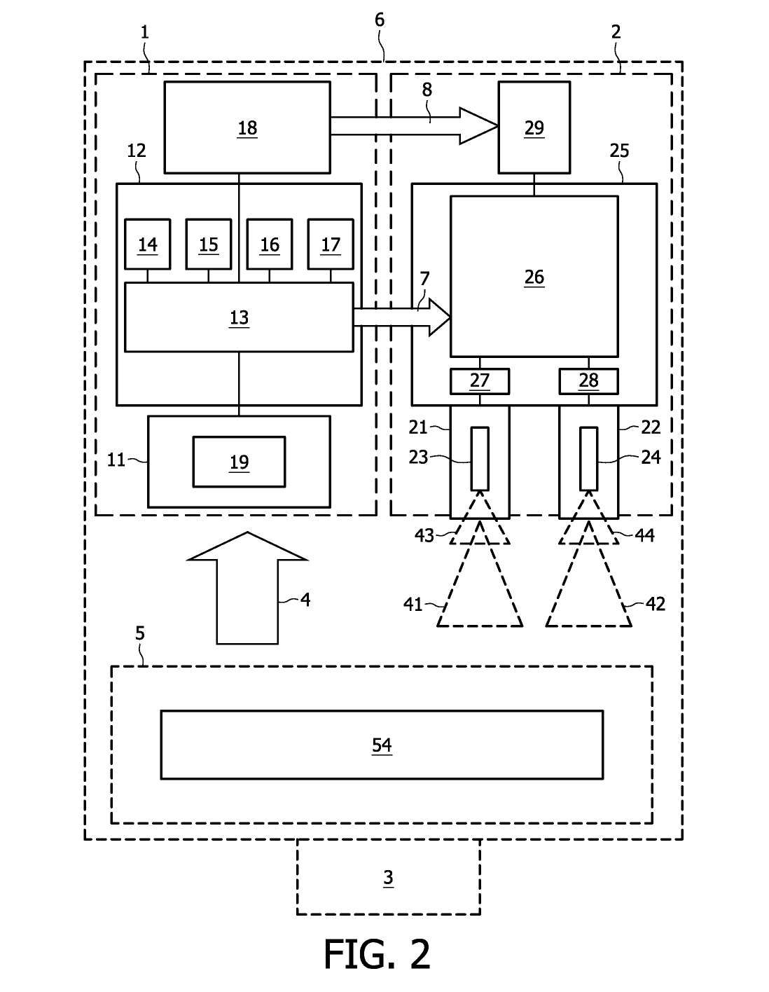

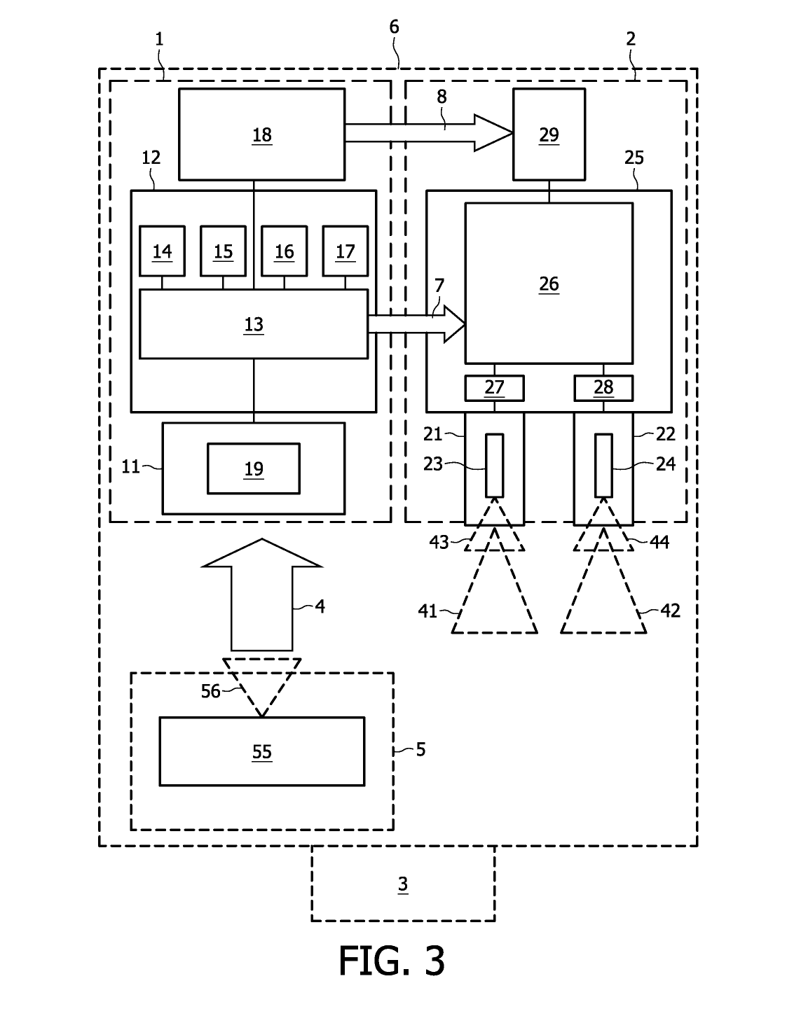

Alternatively, the device 1 may form part of the light-system 2, and/or two or more of the device 1 and the light-system 2 and the signal-system 5 may be sold in a larger package 6. In the embodiment shown in the FIG. 1, the signal 4 may preferably be a wireless signal such as a radio frequency signal. In the embodiments shown in the FIGS. 2 and 3, the signal 4 is an optical signal:

In the FIG. 2, an embodiment of a device 1 according to the invention and of a signal-system 5 (with a reflector) according to the invention is shown. This embodiment only differs from the one shown in the FIG. 1 in that in the signal-system 5 the sensor 51, 52 and the transmitter 53 have been replaced by a reflector 54 for converting light 41-44 into reflected light and in that the receiver 11 has been provided with a sensor 19 for sensing the reflected light and for providing sensing information. The sensor 19 may include a sensor array. So, in this case, the signal 4 comprises the reflected light, in other words the signal 4 is an optical signal comprising a reflection of the light 41-44.

In the FIG. 3, an embodiment of a device 1 according to the invention and of a signal-system 5 (with a light source) according to the invention is shown. This embodiment only differs from the one shown in the FIG. 1 in that in the signal-system 5 the sensor 51, 52 and the transmitter 53 have been replaced by a light source 55 for providing light 56 and in that the receiver 11 has been provided with a sensor 19 for sensing the light 56 and for providing sensing information. The sensor 19 may include a sensor array. So, in this case, the signal 4 is an optical signal comprising the light 56. There might also be a further signal that flows in an opposite direction from the device 1 or the light-system 2 to the signal-system 5, which further signal for example controls the light generation in the signal-system 5.

Alternatively, the light-system 2 may comprise one or more other kinds of light generators, whereby the information is not used to adjust positions until a perfect match is found but where the information is used to make a “good enough” decision and/or where the information is used to make one or more selections and/or to do one or more (de)activations etc. Further alternatively, one or more master-slave configurations could be created and/or several light-systems might be controlled via one device and/or one light-system might be controlled via two or more devices etc. whereby arbiter functions might need to be introduced etc.

So, with respect to the embodiment shown in the FIG. 1, a temporarily or steadily closed loop optical positioning system is proposed. A best possible positioning of the light spots based on objective parameters is guaranteed. During aiming the light spots to the desired objects/surfaces, an optical link is established to guarantee the correct positioning of the light effect. Modeling of dedicated objects using light spots is eased. This all may either be used with motorized light spots (e.g. moving head light spots) or as a tool to aid personnel which is manually adjusting the light spots. The light spot has to communicate with the object to be illuminated. For the communication, certain means are required, generally being categorized into transmitting unit (e.g. LED light unit) and receiving unit (e.g. photo diode). Each transmitting unit and receiving unit might have a certain signal or sensitivity modulation. E.g. a light unit might emit pulsed light at a broad spectrum into a certain solid angle or a receiving unit might be sensitive to a certain wavelength coming from a dedicated direction and having a certain frequency modulation. Some embodiments of the invention can be realized by combining the following items: At the light spot, either the normal effect light of the light spot or additional light sources (which might be deactivated during normal operation) can be used. The light units may have a certain modulation, wavelength, polarization, beam pattern, etc. or any combination thereof.

At the position of the object, the sensor(s) may have a dedicated spatial or spectral sensitivity. In case more than one sensor is used, the several sensors might differ with respect to spatial, spectral, intensity or frequency sensitivity or any combination thereof. Within a system, several sensors with the same or with different properties may be used at the same time to aim several light spots. In addition, more items than just the light spot and the object might be involved, such as a camera or a hand held laser pointer. This is especially true in case of a closed loop system that is active only temporarily. In this case certain sensors are positioned and used only during a set-up phase. In such a case, any item mentioned above will be placed on a certain location only for a short time. The system captures the data (and maybe processes this data and reacts accordingly), while after aiming, the item(s) may be removed for normal operation.

In a simple embodiment, the normal light effect of the light spot is used in combination with one sensor. This is the simplest solution which adds the lowest cost to the system, because only one sensor is required. A task might be to aim a light spot to a target surface (such as a face of a mannequin). From previous calculations and/or estimations, a most suitable light spot is selected. For this previous decision, some information about the setup and the arrangement in the room is required. This data does not need to be very precise (i.e. in terms of the exact orientation of the base plate of the lamps which would be required to pre-calculate the relative angles of its optical axis). During the setup procedure, the light management system advises the installer or the staff of the shop to place the sensor on the object to be illuminated. The measurement values from this sensor are fed to the light management system, preferably via a wireless interface. Now, the system activates the selected light spot. With a simple search algorithm, the lamp is commanded to move along its axes while the system continuously monitors the sensor response. Once some light from the activated lamp hits the sensor, this is detected. Now, the exact position of the lamp is searched by moving the lamp until the sensor response is maximal. As an example, first it moves along one axis and recognizes the maximum response. Then, this axis is frozen at the position of the maximum response and the next axis is adjusted. This may be done for two or three axes. Having found the max there, some iterations may follow until the system can be sure to have the centre of the effect exactly on the position of the sensor and hence the target surface.

To avoid wrong positioning on local maxima (e.g. due to reflection), the expected sensor response can be calculated based on the knowledge of the selected effect (flux, beam angle, distribution pattern etc.) and the distance between light spot and the object. A second, more time consuming possibility is to scan through the entire aiming range of the light spot to guarantee the absolute maximum. Once the search is finished for the first light spot, this light spot might be deactivated to aim a second light spot to the same surface or to adjust the next light spot to the next surface, after the installer or the staff has positioned the sensor on the next object.

In variation, the sensors might be integrated into the objects. Then, no manual placing on the object is required. In addition, the positioning of the light spots could be checked automatically from time to time or upon user request (e.g. after the mannequins have been dressed with new clothes). Based on the result of this repositioning of the light effect(s), some information about the new position of the objects in the room can be gained. This allows automatically updating the room information to have an sufficiently accurate data set for future calculations and selections of light spots. In case the light unit in the light spot has a fast response time, the light unit may be modulated. Then, the sensor reading will also show that modulation, which eases the separation between background light and the desired light affect during the aiming process. Simple amplitude modulation with a certain carrier frequency or more complex coding schemes might be used.

Using several sensors offers the possibility to have a spatial resolution of the sensed light. In that case, the angle of incident of the light effect on the surface can be measured and compared to the desired and calculated configuration. Using this system with manually adjustable lamps is also possible. Then, the information on the accuracy of the positioning has to be displayed to the person who is adjusting the lamps. A simple solution would be to include some indicator lamps with the sensor. The accuracy of the aiming can then be displayed like a traffic light or like a target. It is also possible to integrate one or several additional light sources into the light spot. These additional light sources might have different spectral or spatial emission properties to allow faster or more accurate positioning or simultaneous aiming of several light sources towards a surface using only one sensor. This invention may be used for set up and rearrangement of lighting installations in shops, closed loop position control for motorized lamps, tracking light for moving objects etc.

In addition, with respect to the embodiment shown in the FIG. 2, there are reflective means on the object to be aimed at. These means could be retro-reflective material that reflects all light on the optical axis back to the source. The optical detection means there can therefore measure the reflection. According to a first possibility a sensor located in or close to the light spot is aligned with the light spot in a way that the light spot axis and the optical axis of the sensor are parallel. The selected light spot receives some light reflected back when ever the light spot reaches the target with the beam. Here the sensor might be only flux sensing without spatial sensitivity, then the lamp has to “search” for maximum reflection. This can easily be achieved by slowly moving on one axis after another in both directions and recording the reflected intensity. Having found the max there, some iteration may follow until the light spot can be sure to have the centre of its effect exactly on the position of the reflective means. Best aiming is achieved when on all axes the maximum reflection is measured. To improve the sensitivity of the system the sensor might be equipped with an optical focusing means (lens) so that the monitored area has similar size as the light beam. According to a second possibility, a sensor with multiple sensitivity fields may be used. This allows directly deciding in which direction is to be searched for a highest reflected signal.

Retro-reflecting sheets do not necessarily look nice and might need to be removed after aiming or covered. An interesting variant of this invention is to use reflection means that only reflect in a limited spectral range. E.g. a retro-reflective marker placed on the nose of a mannequin may be covered by paint that does not reflect infrared or ultra violet light. Or some paint that has a very high reflectivity in infrared but that does not show up in visual light might also be used as a reflective marker and might even be part of the object e.g. a mannequin with a fixed reflective area for infrared. A further enhancement of the invention might be to use coded light for the aiming process such that other light sources do not interfere with the aiming process and can be kept on. In a variant of that embodiment the light source gets distinguished by means of spectral characteristic rather than modulation from all other light that may interfere. E.g. the auxiliary aiming light on the object may have a steep infrared spectrum and may be used in combination with a detecting means on the light spot that is equipped with a narrow infrared band-pass filter.

Summarizing, devices 1 comprise receivers 11 for receiving signals 4 coming from signal-systems 5 at objects 3 and comprise converters 12 for converting the signals 4 into control information 7, 8 for controlling light-spot-systems 2 comprising adjustable light spots 21, 22 for illuminating the objects 3. The signal-system 5 may comprise a sensor 51, 52 for sensing light 41-44 and for providing sensing information and a transmitter 53 for transmitting the signal 4 comprising the sensing information to the device 1. Alternatively the signal-system 5 may comprise a reflector 54 for converting light 41-44 into reflected light or may comprise a light source 55 for providing light 56, whereby the receiver 11 comprises a sensor 19 for sensing the reflected light or the light 56 and for providing the sensing information 7, 8. The device 1 may comprise an analyzer 14 for analyzing the sensing information 7, 8 and a memory 15 for storing location information and/or light information and/or signal-system information and a generator 16 for generating search information for letting the light-spot-system 2 search for the signal-system 5.

For example, the signal-system 5 might further comprise a receiver for receiving a command to select a sensitivity of the sensor 51, 52. The signal-system 5 might also comprise a receiver for receiving a command to select the kind of light 56 generated by the light source 55.

While the invention has been illustrated and described in detail in the drawings and foregoing description, such illustration and description are to be considered illustrative or exemplary and not restrictive; the invention is not limited to the disclosed embodiments. For example, it is possible to operate the invention in an embodiment wherein different parts of the different disclosed embodiments are combined into a new embodiment.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A device (1) for providing control information (7, 8) for controlling a light-system (2) for illuminating an object (3), the device (1) comprising
a receiver (11) for receiving a signal (4) coming from a signal-system (5) at the object (3), and
a converter (12) for converting the signal (4) into the control information (7, 8).

2. The device (1) according to claim 1, the signal-system (5) comprising
a sensor (51) for sensing light (41, 43) and for providing sensing information, and
a transmitter (53) for transmitting the signal (4) comprising the sensing information to the device (1).

3. The device (1) according to claim 2, the converter (12) comprising an analyzer (14) for analyzing the sensing information in the signal (4) and a memory (15) for storing location information and/or light information and/or signal-system information, and the device (1) further comprising a generator (16) for generating search information for letting the light-system (2) search for the signal-system (5).

4. The device (1) according to claim 2, the control information (7, 8) comprising an aiming parameter and/or a location parameter and/or a light parameter, and the light (41, 43) comprising an individualization parameter, and the light (41, 43) coming from a light of the light-system (2) or from another light source (23).

5. The device (1) according to claim 2, the light-system (2) comprising an adjustable light spot (21) and a further adjustable light spot (22), and/or the signal-system (5) further comprising a further sensor (52) for sensing further light (42, 44) and for providing further sensing information.

6. The device (1) according to claim 1, the signal-system (5) comprising a reflector (54) for converting light (41, 43) into reflected light, the signal (4) comprising the reflected light, and the receiver (11) comprising a sensor (19) for sensing the reflected light and for providing sensing information and/or a sensor array for sensing the reflected light and for providing sensing information.

7. The device (1) according to claim 6, the converter (12) further comprising an analyzer (14) for analyzing the sensing information and a memory (15) for storing location information and/or light information and/or receiver information and/or signal-system information, and the device (1) further comprising a generator (16) for generating search information for letting the light-system (2) search for the signal-system (5).

8. The device (1) according to claim 6, the control information (7, 8) comprising an aiming parameter and/or a location parameter and/or a light parameter, and the light (41, 43) and/or the reflected light comprising an individualization parameter, and the light (41, 43) coming from a light of the light-system (2) or from another light source (23).

9. The device (1) according to claim 1, the signal-system (5) comprising a light source (55) for providing light (56), the signal (4) comprising the light (56), and the receiver (11) comprising a sensor (19) for sensing the light (56) and for providing sensing information and/or a sensor array for sensing the light (56) and for providing sensing information.

10. The device (1) according to claim 9, the converter (12) further comprising an analyzer (14) for analyzing the sensing information and a memory (15) for storing location information and/or light information and/or receiver information and/or signal-system information, and the device (1) further comprising a generator (16) for generating search information for letting the light-system (2) search for the signal-system (5).

11. The device (1) according to claim 9, the control information (7, 8) comprising an aiming parameter and/or a location parameter and/or a light parameter, and the light (56) comprising an individualization parameter.

12. The device (1) according to claim 1, the device (1) further comprising an indicator (18) for indicating the control information (8) to a person for controlling the light-system (2), or the device (1) further comprising a controller (13) for automatically controlling the light-system (2) in response to the control information (7).

13. A light-system (2) comprising the device (1) according to claim 1.

14. A signal-system (5) to be used at an object (3) for supplying a signal (4) to a device (1) for providing control information (7, 8) for controlling a light-system (2) for illuminating the object (3), the device (1) comprising a receiver (11) for receiving the signal (4) coming from the signal-system (5) and comprising a converter (12) for converting the signal (4) into the control information (7, 8), the signal-system (5) comprising
either a sensor (51) for sensing light (41, 43) and for providing sensing information and a transmitter (53) for transmitting the signal (4) comprising the sensing information to the device (1),
or a reflector (54) for converting light (41, 43) into reflected light, the signal (4) comprising the reflected light, and the receiver (11) comprising a sensor (19) for sensing the reflected light and for providing sensing information and/or a sensor array for sensing the reflected light and for providing sensing information,
or a light source (55) for providing light (56), the signal (4) comprising the light (56), and the receiver (11) comprising a sensor (19) for sensing the light and for providing sensing information and/or a sensor array for sensing the light and for providing sensing information.

15. A method for providing control information (7, 8) for controlling a light-system (2) for illuminating an object (3), the method comprising the steps of
receiving a signal (4) coming from a signal-system (5) at the object (3), and
converting the signal (4) into the control information (7, 8).
